(19) United States
(12) Patent Application Publication
(10) Pub. No.: US 2006/0274131 A1
(43) Pub. Date: Dec. 7, 2006

(54) Inkjet recording apparatus

(75) Inventors: Masatoshi Noguchi, Kanagawa (JP); Hiroshi Yamamoto, Kanagawa (JP); Sachio Shibata, Kanagawa (JP); Michiharu Nishijima, Kanagawa (JP); Masahide Yonao, Kanagawa (JP); Takuya Yamada, Kanagawa (JP)

Correspondence Address: DRINKER BIDDLE & REATH (DC), 1500 K STREET, N.W., SUITE 1100, WASHINGTON, DC, 20005-1209, US

(73) Assignee: Graphtec Kabushiki Kaisha

(21) Appl. No.: 11/440,433

(22) Filed: May 25, 2006

(30) Foreign Application Priority Data
May 27, 2005 (JP) P2005-154757
Oct. 11, 2005 (JP) P2005-295801
Oct. 11, 2005 (JP) P2005-295802
Oct. 11, 2005 (JP) P2005-295803
Apr. 20, 2006 (JP) P2006-116401

(51) Int. Cl. B41J 2/175

(52) U.S. Cl. 347/85

(57) ABSTRACT

An inkjet recording apparatus that moves an inkjet head mounted on a carriage in a main scan direction and ejects ink to perform recording, includes: an ink tank which is supported by a recording apparatus body and stores the ink; and an ink tube which constitutes an ink path from the ink tank to the inkjet head. A predetermined amount of ink is contained in the inkjet head, and the ink tube can be connected to the inkjet head.

### BACKGROUND OF THE INVENTION

1. Field of the Invention

The present invention relates to an inkjet recording apparatus.

2. Description of the Related Art

In general, an inkjet recording apparatus includes inkjet recording heads for selectively ejecting ink, a carriage for mounting the recording heads, a main scan driving unit for reciprocally moving the carriage in a main scan direction, and a sub scan driving unit for conveying a recording paper in a sub scan direction. The inkjet recording apparatus forms a desired image on the recording paper by synchronizing ink ejections of the main and sub scan recording heads.

As an ink supply means, a method of supplying the ink from the ink cartridge to the recording head through the joint for connecting the ink cartridge and the recording head, or a method of supply the ink by integrating the ink cartridge and the recording head in a single body are used. Since a negative pressure should be exerted into the ink to supply the ink to the nozzle of the recording head, such an ink cartridge is provided with a negative pressure tool for absorbing the ink in the compressed porous body to generate a negative pressure for the ink by a capillary motion of the porous body. In addition, when the ink is consumed by a recording operation, the ink cartridge is detachable mounted on the carriage or the recording head so as to be replaced with a new cartridge according to the type of the ink cartridge. (See, e.g. JP-A-2003-326732.)

In the inkjet recording apparatus having a type that the cartridge is mounted on the carriage, there is a problem that, as the amount of the ink stored in the cartridge increases, the weight becomes heavy, so that the carriage cannot be moved in a high speed. Therefore, the capacity of the cartridge cannot be sufficiently increased. For example, this type is not proper for the inkjet recording apparatus for performing a recording operation on a large recording paper such as a size of A0. For this reason, in such an inkjet recording apparatus for use in a large format, a method of supplying the ink from the ink tank mounted on a recording apparatus body to the recording head mounted on the carriage through a tube has been adopted.

FIG. 14 is a view showing main components of such a conventional inkjet recording apparatus for use in a large format. In FIG. 14, the reference numeral 1 designates a platen where the recording paper conveyed in a sub-scan direction (in an X-axis direction) by the sub-scan driving unit (not shown in the drawing) is mounted. The reference numeral 2 designates a guide rail extended along a main scan direction perpendicular to the conveyance direction of the recording paper mounted on the platen 1. The reference numeral 3 designates a carriage slidably installed in the guide rail 2. The reference numeral 4 designates an inkjet head for ejecting an ink droplet into the recording paper. The reference numeral 5 designates a flexible tube for supplying the ink to the head 4. The reference numeral 6 designates an ink tank for storing the ink to be supplied to the head 4.

As shown in the drawing, the carriage 3 is constructed so as to be moved along the guide rail 2 in a main scan direction (a Y-axis direction). The carriage 3 is provided with four recording heads 401 to 404.

Each of the recording heads 401 to 404 is connected to the ink tank 6 which stores different color inks, and an ink flow path from the recording heads 4 though ink tube 5 to ink tank 6 constitutes a hermetically sealed structure. For this reason, when the ink is ejected from the ejection nozzle formed in the recording head 4, the inside of the recording head 4 becomes a negative pressure according to the ejected ink amount. Subsequently, according to this negative pressure, the ink is supplied from the ink tank 6 through the ink tube 5 to the recording head 4.

On the platen 1 just under the moving path of the recording head 4, the recording paper is movably mounted in a sub-scan direction (in an X-axis direction). During the recording operation, the recording paper is moved in an X-axis direction, and the recording head 4 is moved in a Y-axis direction. At the same time, the ink is selectively ejected from each of the recording heads 401 to 404 to achieve a desired recording. (See, e.g. JP-A-2002-240316.)

In the aforementioned inkjet recording apparatus, an initial charging operation for inducing the ink from the ink cartridge through the ink tube to the ejection nozzle of the inkjet recording heads is necessary. As described in JP-A-2003-326732, the conventional inkjet recording apparatus is provided with a suction cap which faces the recording heads and is closely attached to the head surface if necessary, and a suction pump connected to the suction cap, so that the ejection nozzle is sucked by the suction pump to induce the ink in a new cartridge to the nozzle of the head. As another method, if the inkjet recording apparatus has an ink tank, the apparatus is provided with a pump driven by a driving source such as a motor or manually driven to discharge the air in the sub-tank of the recording head, so that the sub-tank is charged with the ink from the ink tank through the ink tube by using the pump. A still another method, a pump is provided in the middle of an ink flow path from the ink tank through the tube to the reading heads, and the ink is supplied from the ink tank to the recording heads by using this pump. Therefore, an operation for initiating a job is necessary, and a relating work becomes cumbersome. In addition, since the number of components is entirely increased, the production cost is increases as well as the size of the apparatus itself becomes larger.

In this type of inkjet recording apparatus, if a durability lifespan when the nozzle of the inkjet head cannot eject the ink is nearly reached for a long time use, an ink ejection defect occurs, or the recording quality is decreased. Therefore, the inkjet head should be replaced.

In the inkjet recording apparatus in which the inkjet head has a negative pressure by ejecting the ink according to the recording operation and the ink is accordingly supplied through the ink tube from the ink tank, the ink path extending from the inkjet head through the ink tube to the ink tank is hermetically sealed, and an atmospheric pressure should be exerted on the ink stored in the ink tank, i.e., the inside of the ink tank should be atmospherically opened, in order to supply the ink. Therefore, as described in JP-A-2003-326732, the ink tank fixed at the recording apparatus side is connected to the ink tube for supplying the ink to the inkjet head near a bottom surface, and an atmospheric opening hole is provided near a top surface of the ink tank. In this construction, when the ink in the ink tank is consumed according to the recording operation, the ink should be replenished in the ink tank. A job for directly replenishing the ink to the ink tank requires the greatly possible care, or otherwise, the recording apparatus or the operator itself will be contaminated. Therefore, this job is significantly cumbersome for unskilled persons. In order to solve this problem, there have been proposed many kinds of methods in which the ink tank is constructed as an attachable/detachable cartridge to/from the recording apparatus body and replaced to replenish the ink. However, it is necessary to provide a construction for preventing leakage of the remaining ink in the ink tank when the atmospheric opening pipe structure is formed in the ink tank, or when the ink tank is removed from the recording apparatus body. As a result, the ink tank structure becomes complicated, the number of components increases, and the production cost accordingly increases.

The present invention is contrived to solve the above-described problems.

### SUMMARY OF THE INVENTION

The inkjet recording apparatus according to the present invention is constructed such that an inkjet head capable of storing a predetermined amount of ink in advance is provided, a recording operation can be performed by the ink that has been stored in advance, and the inside of the inkjet head becomes a negative pressure by ejecting the ink according to the recording operation, so that the ink can be supplied from the ink tank through the ink tube to the inkjet head.

The inkjet recording apparatus according to the present invention is constructed such that an ink storage unit capable of storing a predetermined amount of ink in advance is provided, an inkjet head which is mounted on a carriage, moves along a main scan direction, and ejects the ink to perform a recording operation is provided, the inkjet head is provided with a cylindrical member where a connection portion of the ink tube for forming an ink flow path from the ink tank is engaged with, and a slanted plane for guiding the connection portion of the ink tube to the cylindrical member is provided. In addition, the connection portion of the ink tube is provided with an elastic member where a slit for opening and closing the ink path is formed, and the inkjet head is provided with a pipe which is inserted into the slit of the elastic member when the connection portion of the ink tube is engaged with the cylindrical member, and elastically deforms the elastic member to open the ink path to which the ink storage unit of the inkjet head is connected.

The inkjet recording apparatus according to the present invention is constructed such that the connection portion of the ink tube which constitutes an ink path from the inkjet head to the inkjet tank is attached to the cover member which is openalby installed with respect to the carriage, and the ink tube is connected to the inkjet head according to the opening and closing operation of the cover member with respect to the carriage. In addition, the connection portion of the ink tube is swingably attached in a plane direction of the cover member. Furthermore, the cover member is rotatably supported to an opposite side of the inkjet head with a guide rail on which the carriage slides interposed therebetween.

The inkjet recording apparatus according to the present invention includes an ink tank unit for storing the ink, an ink container having an atmospheric opening hole and an ink supply inlet that are disposed on the same plane and distant from each other in a vertical direction with respect to the installation plane, a first joint for connecting the ink supply inlet of the ink container to the ink tube, and a second joint connected to the atmospheric opening hole of the ink container to atmospherically open the ink container, wherein the first and second joints are supported by the recording apparatus body, and wherein the ink container is detachably mounted on a recording apparatus body. Also, the first joint is provided with a liquid absorber. In addition, a guide member is adjacently disposed on a plane where the atmospheric opening hole and the ink supply inlet of the ink container are provided, and the recording apparatus body is provided with a rail member where the guide member is abutted and slid. In addition, the second joint is provided with a flow path for atmospherically opening the ink container and a downward flow path. In addition, a unique protrusion according to a type of the inkjet container is formed on a plane where the atmospheric opening hole and the ink supply inlet are provided in the ink container, and the recording apparatus body is provided with a protrusion which faces the unique protrusion of the ink container to interfere with the unique protrusion of a different type of ink container such that the atmospheric opening hole and the ink supply inlet are not connected to the first and second joints.

According to the inkjet recording apparatus of the present invention, an initial ink charging operation in the ink tube is not required when a new apparatus is initially operated.

According to the inkjet recording apparatus of the present invention, the inkjet head is provided with a cylindrical member into which the connection portion of the ink tube is inserted, and the slanted plane of the cylindrical member guides the connection portion of the inserted ink tube. Therefore, it is possible to connect the ink tube with the inkjet head in a simple and secured manner.

According to the inkjet recording apparatus of the present invention, the atmospheric opening hole and the ink supply inlet are provided on the same plane of the ink container and distant from each other in a vertical direction. Therefore, it is possible to simplify the construction of the ink container. In addition, the first joint of the ink tank unit is provided with a liquid absorber. Therefore, it is possible to prevent contamination of the recording apparatus body by the ink flowed from the ink tank when the ink container is separated. In addition, the guide member is adjacently disposed on a plane where the atmospheric opening hole and the ink supply inlet of the ink container are provided. Therefore, it is possible to surely connect the ink container with the first and second joints. In addition, the second joint is provided with a flow path for atmospherically opening the ink container and a downward flow path. Therefore, it is possible to prevent contamination of the recording apparatus body caused by the ink leaked from the atmospheric opening hole of the ink container. In addition, a unique protrusion according to a type of the inkjet container is formed on a plane where the atmospheric opening hole and the ink supply inlet are provided in the ink container, and the recording apparatus body is provided with a protrusion which faces the unique protrusion of the ink container. An inappropriate ink container having a different type from that of the ink container to be connected is not connected to the first and second joints.

### BRIEF DESCRIPTIONS OF THE DRAWINGS

FIG. 1 is a view showing a construction of an inkjet recording apparatus according to the present invention;

FIG. 2 is a view showing the inkjet recording apparatus according to the present invention;

FIG. 3 is a perspective view showing main components of the inkjet recording apparatus according to the present invention;

FIGS. 4A and 4B are cross sectional views showing a construction of the inkjet recording apparatus according to the present invention;

FIG. 5 is a view showing constructions of an ink head and a cover member of the inkjet recording apparatus according to the present invention;

FIG. 6 is a view showing a construction of the ink head of the inkjet recording apparatus according to the present invention;

FIGS. 7A and 7B are views for explaining connection of the ink tube and the inkjet head in the inkjet recording apparatus according to the present invention;

FIG. 8 is a view showing a construction of an ink tank unit in the inkjet recording apparatus according to the present invention;

FIG. 9 is a view showing a construction of an ink tank unit in the inkjet recording apparatus according to the present invention;

FIG. 10 is a modeling diagram showing a construction of an ink supply system and main parameters in the inkjet recording apparatus according to the present invention;

FIG. 11 is a view showing a pressure stabilizer in the inkjet recording apparatus according to the present invention;

FIG. 12 is a view showing an ink speed in the ink tube in the inkjet recording apparatus according to the present invention;

FIG. 13 is a view showing a change in ink height in the inkjet head of the inkjet recording apparatus according to the present invention;

FIG. 14 is a view showing a construction of a conventional inkjet recording apparatus;

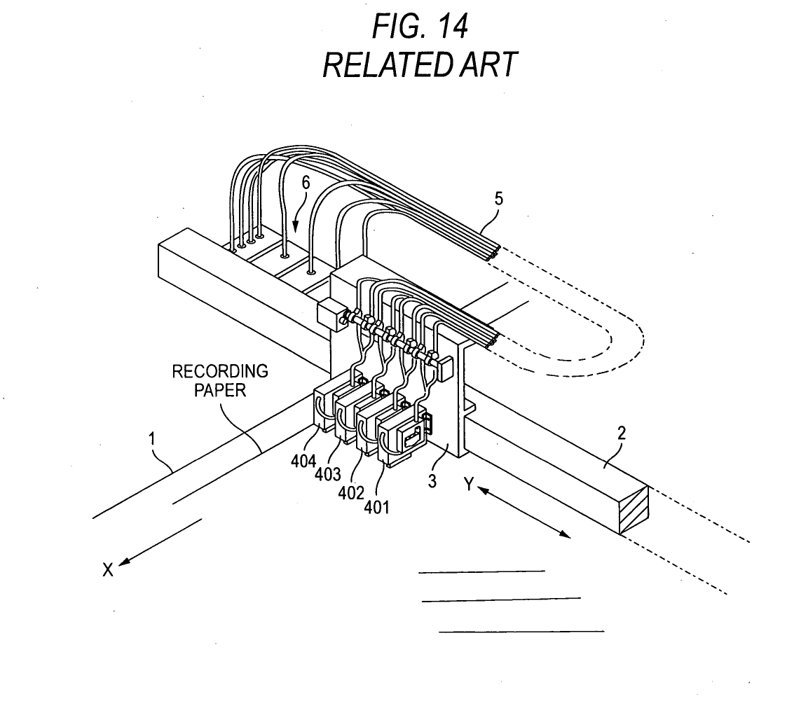

FIGS. 15A to 15C are views for explaining connection of the ink tube and the inkjet head in an inkjet recording apparatus according to the present invention;

FIG. 16 is a view showing a construction of the inkjet recording apparatus according to the present invention;

FIG. 17 is a cross sectional view showing a joint of an ink supply inlet of an ink tank unit according to the present invention;

FIG. 18 is a view showing a construction of an ink tank unit of the inkjet recording apparatus according to the present invention; and

FIG. 19 is a view showing a construction of an ink tank unit of the inkjet recording apparatus according to the present invention

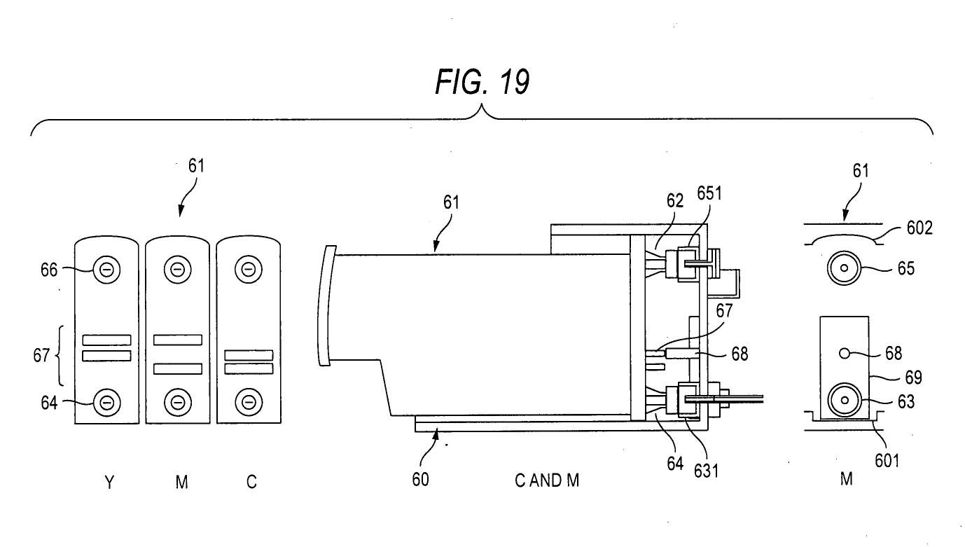

### DETAILED DESCRIPTION OF THE INVENTION

Hereinafter, an inkjet recording apparatus according to the present invention will be described with reference to the accompanying drawings.

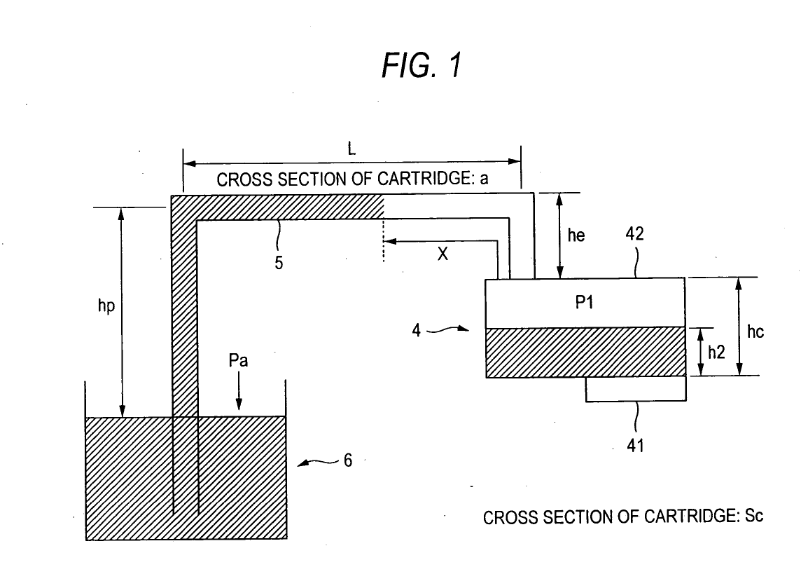

FIG. 1 is a view for explaining a construction (principle) of the inkjet recording apparatus according to the present invention. In the figure, the same components as those of the afore-mentioned conventional apparatus are denoted by the same reference numerals.

The present invention has a feature that a predetermined amount of ink is contained in an inkjet head 4 in advance in an unused state of a product.

In the embodiment, the inkjet head 4 is constructed by integrating a head portion 41 having an ejection nozzle for selectively ejecting the ink and a cartridge 42 for supplying the ink to the head portion 41 and containing a predetermined amount of the ink. As shown in JP-A-2003-326732, the cartridge 42 may be detachably provided to the head portion 41.

In the inkjet head 4 according to the present invention, an amount of ink corresponding to an ink height h2 shown in the figure is contained in advance to the cartridge 42, and a predetermined cavity (having an air amount P1) corresponding to a difference between a total height hc of the cartridge 42 and the ink height h2 is formed.

An ink tank 6 is supported by a recording apparatus body, and the atmospheric pressure Pa is exerted on the ink contained in the ink tank.

One end of the ink tube 5 is detachably connected to an upper portion, that is, the cavity portion P1 of the cartridge 42 of the inkjet head 4, and an ink path formed with the cartridge 42, the ink tube 5, and the ink tank 6 is in a closed state.

In the inkjet recording apparatus according to the present invention, when the one end of the ink tube 5 is connected to the ink cartridge 42, a front surface of the ink is located at a position of the ink tube 6, that is, the ink path. At this time, a distance from one end (an end contacting the cartridge) of the ink tube 5 to the front surface of the ink is defined as X. In this state, the inkjet recording apparatus according to the present invention starts a recording operation.

When the recording operation starts, the ink is ejected from the head portion 41, so that a pressure is exerted on an inner portion of the cartridge 42. Since the ink path is in the closed state, and since the atmospheric pressure Pa is exerted on the ink of the ink tank 6, the ink is sucked from the ink tank 6, so that the front surface of the ink of the ink path is moved (X is reduced). While the recording operation is performed to eject the ink of the cartridge 42, at a time that the ink height h2 becomes a predetermined height, the ink reaches the one end of the ink tube 5. After that, the same amount of the ink as that of the ink ejected from the head portion 41 is dropped from the ink tube 5 into the cartridge 42, so that the ink is supplied from the ink tank 6.

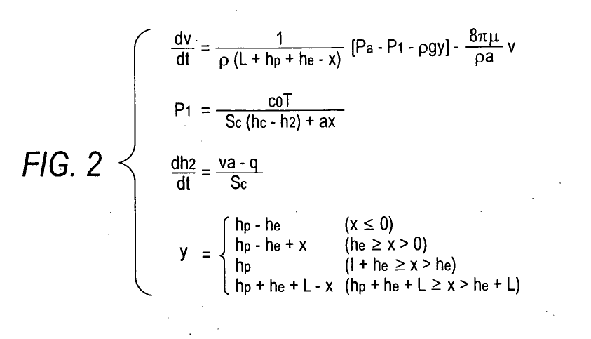

FIG. 2 shows an equation of motion of the ink, a state equation of a gas in the cartridge 41, and a volume of the ink ejected per a unit time in the inkjet recording apparatus shown in FIG. 1 according to the present invention.

As describe above in detail, in inkjet recording apparatus according to the present invention, the recording operation can be initiated without performing an initial charging operation due to the ink previously stored in the inkjet head. The ink starts to be supplied from the ink tank 6 from the time point when the amount of the ink in the inkjet head reaches a predetermined quantity by sequentially performing the recording operation. Thereafter, the recording is performed by constantly maintaining the amount of the ink in the inkjet head. As a result, it is possible to remove the suction means such as a pump that has been required in prior arts, and omit the initial charging operation of the ink.

Now, the inkjet recording apparatus according to the present invention for adopting the aforementioned principles will be described in detail.

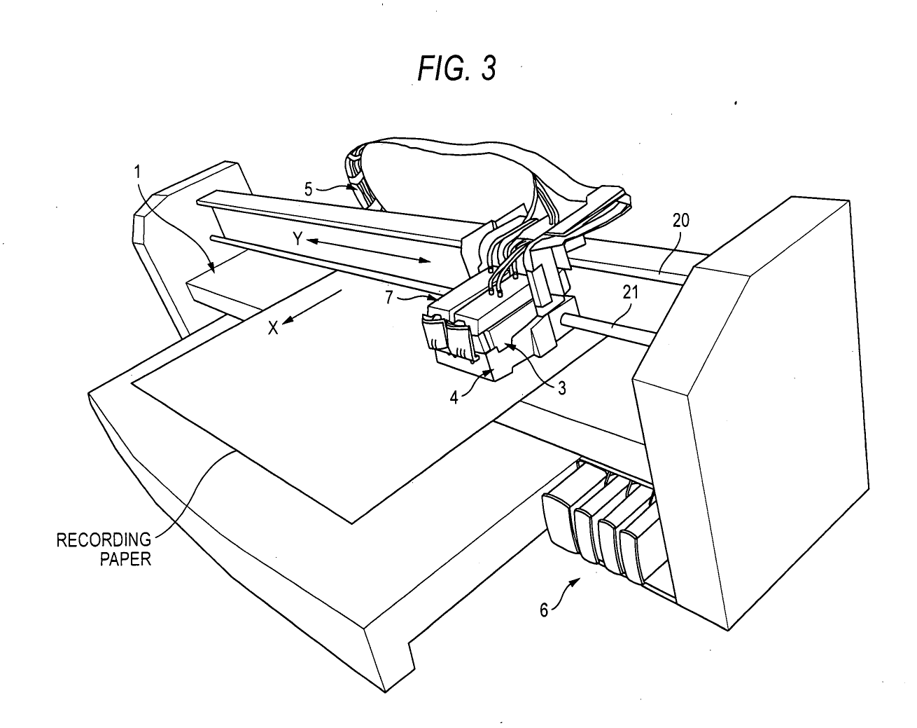

FIG. 3 is a perspective view showing main components of the inkjet recording apparatus according to the present invention. Similar to the aforementioned conventional apparatus, the inkjet recording apparatus according to the present invention is constructed such that the recording paper mounted on the platen 1 is conveyably supported by a sub-scan driving unit (not shown in the drawing) in a sub-scan direction (in an X direction in the drawing), the carriage 3 slides on a guide rail 20 and a guide shaft 21 that can be extended in a main scan direction perpendicular to the conveyance direction of the recording paper to move the inkjet head 4 along a main-scan direction (in a Y-direction in the drawing), and an ink droplet is ejected from the inkjet head 4 to allow a desired recording to be performed on the recording paper. In addition, the inkjet head 4 is supplied with the ink from the ink tank 6 supported by the recording apparatus body through the ink tube 5.

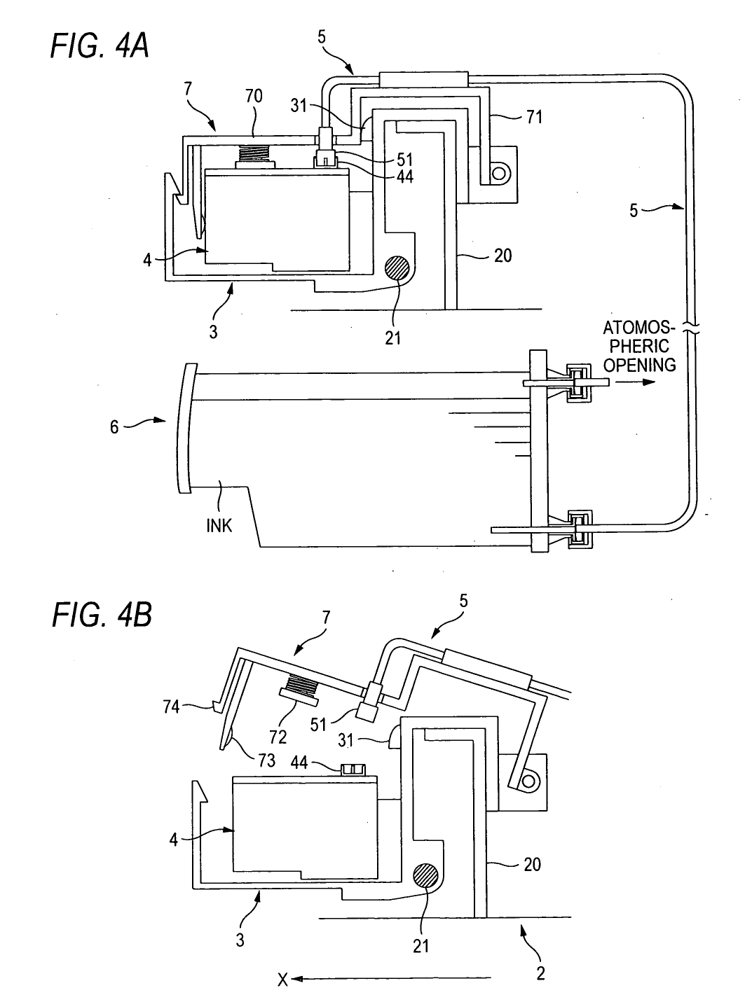

FIG. 4 is a cross sectional view showing a construction of the inkjet recording apparatus according to the present invention. The inkjet recording apparatus includes the carriage, the inkjet head, and the cover member. An ink flow path is extended from the inkjet head through the ink tube to the ink tank. As described above, the carriage is slidably supported by the guide rail 20 and the guide shaft 21, and movably installed toward a main scan direction by the main scan driving unit. This cover member 7 includes a cover member 70 for closing the inkjet head 4 and an arm 71 for supporting the cover member 70. The arm 71 is rotatably supported to an opposite side of the inkjet head with a guide rail 20 on which the carriage 3 slides interposed therebetween. In addition, the cover member 70 includes a head press portion 72 which is abutted on the inkjet head 4 and presses the inkjet head 4 toward the carriage 3 by a restoration force of a compressive spring when the cover member 7 is closed, a lever 73 elastically deformed when it is similarly abutted on the inkjet head 4 so as to press the inkjet head 4 toward the guide rail 20 to support it, and a hook 74 engaged with the carriage 3 to fix the cover member 7. The cover member 70 is also supported by the septum unit 51 which functions as a connecting portion of the ink tube 5.

The other side of the ink tube 5 is connected to an ink tank 6 installed in a recording apparatus body. The inkjet head 4 constructed to be hermetically sealed as described below, the ink tube 5 connected to the inkjet head 4, and the ink tank 6 connected to the ink tube 5 constitute an ink path through which the ink flows. The ink tank 6 has an atmospheric opening portion provided in a vertical direction with respect to a mount surface, as shown in the drawing, to connect the inside of the ink tank to an external atmosphere. For this reason, an atmospheric pressure is exerted on the ink stored in the ink tank 6.

As shown in FIGS. 4 to 6, the ink jet head 4 includes a head portion 41 having an ink ejection nozzle array on a surface facing the recording paper, i.e., a lower surface, a cartridge 42 functioning as an ink storage unit for storing the ink, a lid 43 for sealing an upper opening of the cartridge 42, a cylindrical member 44 attached to the lid 43, a pipe 45 provided in the cylindrical member 44, and an ink retaining body 46 stored in the cartridge 42.

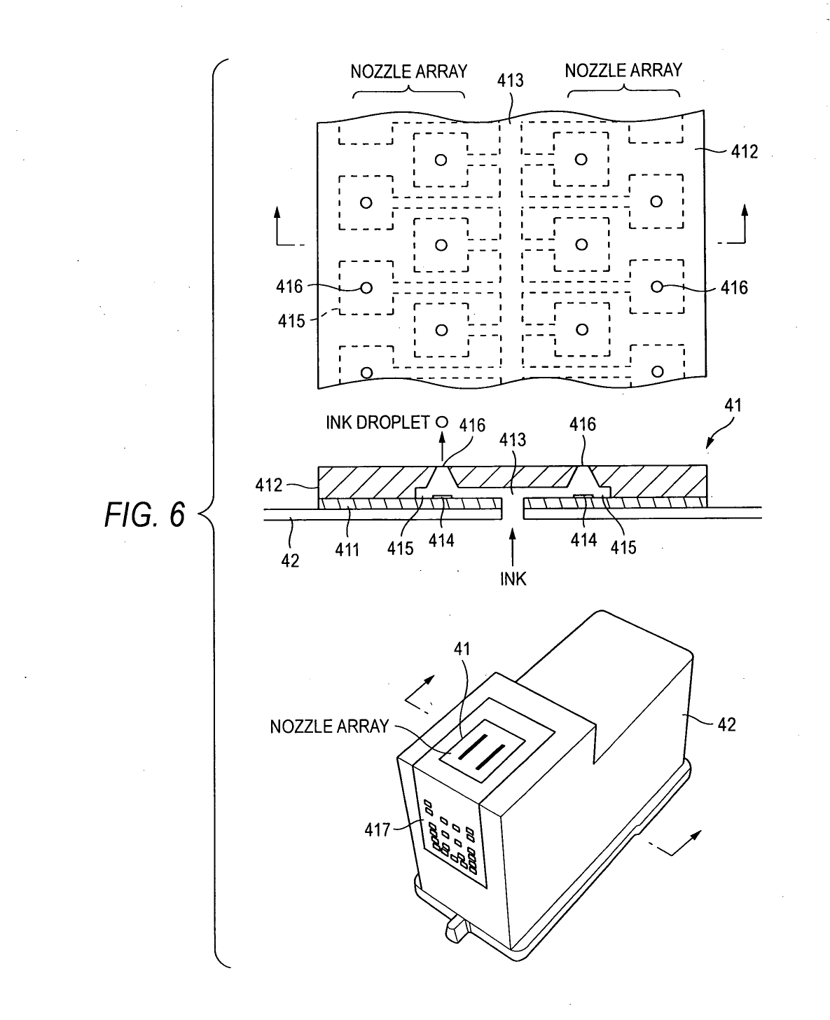

As shown in FIG. 6, the inkjet head 4 according to the present invention is a thermal type inkjet head in which a plurality of ink ejection nozzles 416 are arranged in a predetermined line pattern and the ink is ejected by selectively activating a thermo-resistor type heater 414 corresponding to each nozzle 416. When the inkjet head 4 is set in the cartridge 3, a plurality of contact pads 417 electrically connected to each heater 414 make contact with connection terminals (not shown in the drawing) of the cartridge 3, so that a control portion of the inkjet recording apparatus can control the heater 104.

As shown on center of FIG. 6, the head portion 41 includes a silicon member 411 provided on the cartridge 42 and a nozzle plate 412 provided on the silicon member 411. An ink supply channel 413, a heater 414, and a chamber 415 are provided between the nozzle plate 412 and the silicon member 411. In addition, a nozzle 416 is provided on the nozzle plate 412 in a position corresponding to the heater 414 and the chamber 415. The ink retained in the cartridge 42 flows from the ink supply channel 413 to the chamber 415 by virtue of gravitation and a capillary action, and is filled in the head portion 41.

The ink retaining member 45 is made of a porous material such as urethane, formaldehyde, or polyetherpolyurethane, and stored in the cartridge 42 in a compressed state. In the inkjet head 4 according to the present invention, a predetermined amount of ink is stored in advance in the ink retaining body 46. The ink retained in the ink retaining body 46 is hermetically sealed in the inkjet head 4 by closely covering the cartridge 42 with the lid 43 which has the cylindrical member 44 and the pipe 45, and welding the lid 43 as described below.

This ink retaining body 46 prevents ink droplets from falling down from the ink ejection nozzle 416 of the head portion 41 as well as stores the ink in the inkjet head 4. Furthermore, the ink retaining body 46 prevents bubbles from being generated in the inkjet head 4 when the inkjet head 4 moves in a high speed together with the carriage 3.

The pipe is a cylindrical shape tube member. As described below, the ink tube 5 is connected to the inkjet head 4, so that the ink is supplied from the ink tank 6 through the ink tube 5 to the cartridge 42 of the inkjet head 4.

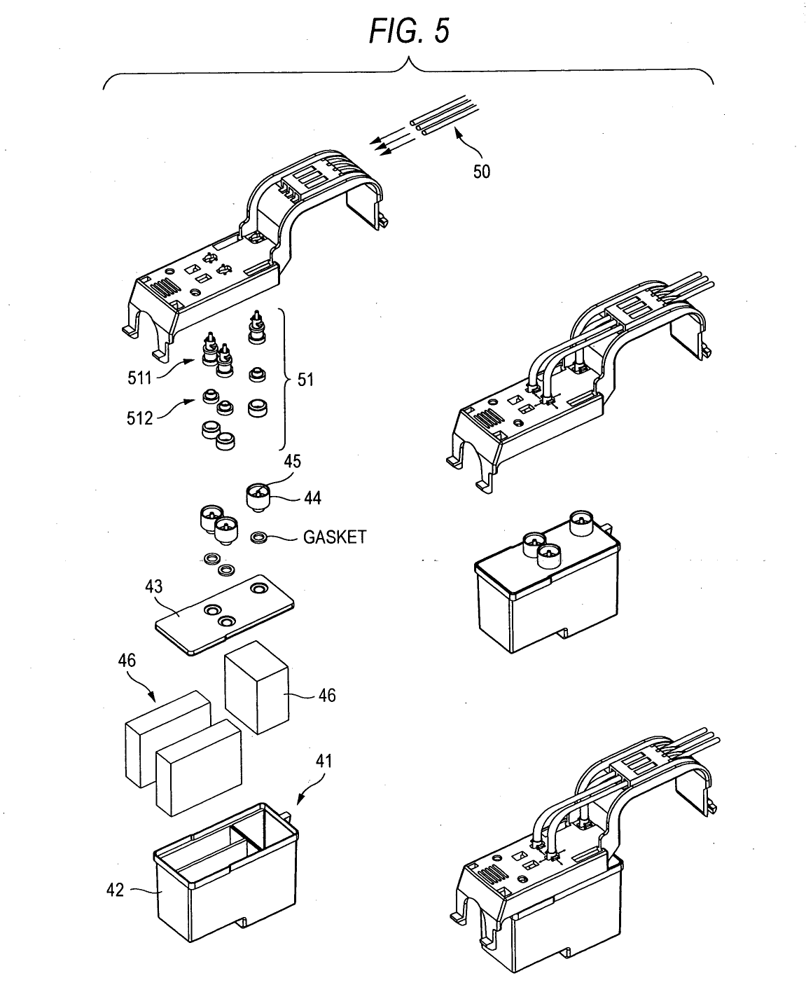

In this embodiment, black ink having its dedicated inkjet head, and color ink including cyan, magenta, and yellow colors (C, M, and Y) are contained in the corresponding containers partitioned in the cartridge 42 (refer to FIG. 5). Two kinds of color inkjet heads are provided in the carriage 3. One cylindrical member 44 and one pipe 45 are mounted on the black inkjet head, and three cylindrical members 44 and three pipes 45 are mounted on the color inkjet head. The number of cylindrical members 44 or pipes 45 corresponds to the number of the contained ink types.

The septum unit 51 functioning as a connecting portion of the ink tube 5 includes a connector 511 of which the center portion for connecting the ink tube 50 is a cylindrical tube shape, an elastic member 512 which is formed of rubber or the like, makes contact with an end portion of the connector 511, and has a slit in its center portion, and a cap 513 for capping the connector 511 in such a way that the slit in the center of the elastic member 512 is exposed and the elastic member 512 is covered. An ink path is formed by a combination of the ink tube 50, the cylindrical tube of the connector 511, and the slit of the elastic member 512.

The septum unit 51 is engaged in the cylindrical member 44 provided in the inkjet head 4 to connect the ink tube 5 with the inkjet head 4.

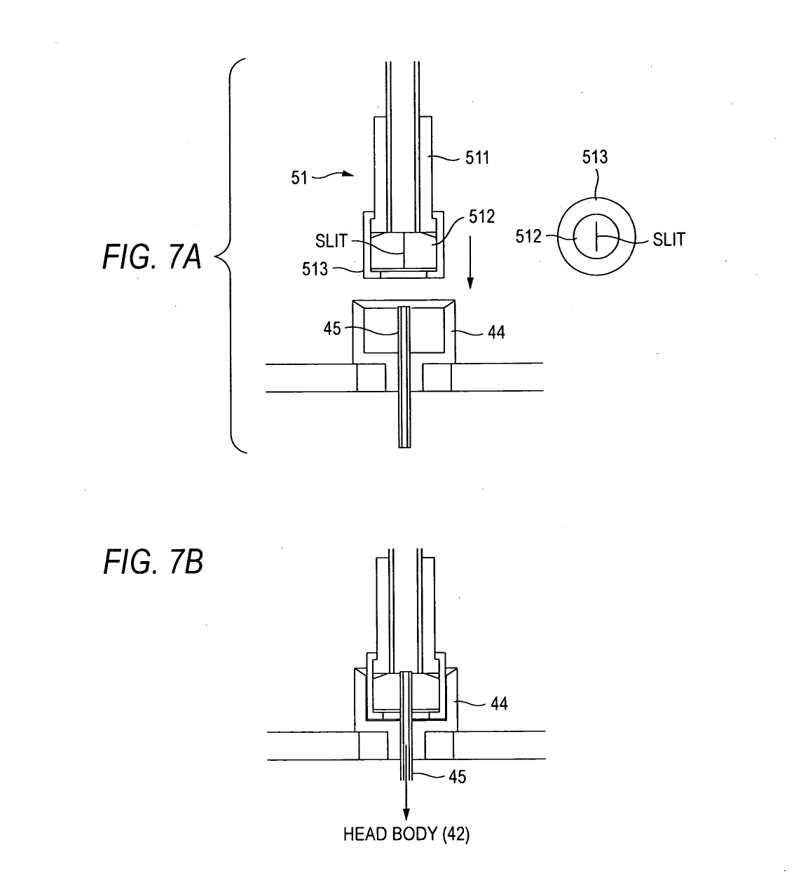

FIGS. 7A and 7B is a view for explaining connection of the ink tube 5 and the inkjet head 4 in the inkjet recording apparatus according to the present invention. As shown in FIG. 7A, the slit of the elastic member 512 is closed when the septum unit 512 is not connected to the inkjet head 4, so that the ink path in the ink tube 5 is closed.

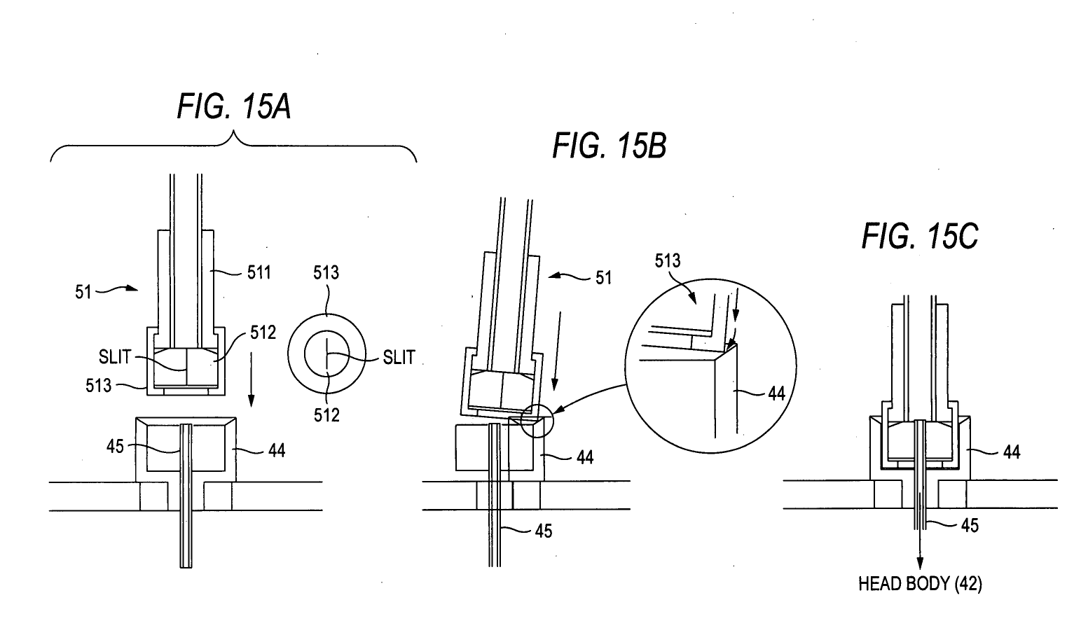

On a top portion of the cylindrical member 44 in the inkjet head 4 according to the present invention, a slanted plane is provided from an outer circumference to the inside (i.e., in the shape of a cone). As shown in FIG. 15B, when the ink tube is connected to the inkjet head 4, the end portion of the cap 513 of the septum unit 51 makes contact with the cylindrical member 44 of the inkjet head 4, and the cap 513 slides on the slanted plane of the cylindrical member 44 by pressing it and is guided to the center, so that the pipe 45 of the inkjet head 4 makes contact with the slit of the elastic member 512. In addition, the elastic member 512 is elastically deformed by the pipe when the septum unit 512 is inserted with pressure so that the slit can be opened. When, the septum unit 51 is fully inserted into the cylindrical member 44, the ink flow path of the ink tube 5 is connected with a head body 42 which is an ink storage unit of the inkjet head 4.

In the inkjet recording apparatus according to the present invention, the connection between the ink tube 5 and the inkjet head 4 is performed in synchronization with a open/close operation for the carriage 3 of the cover member 7. In other word, the septum unit 51 functioning as a connection portion of the ink tube 5 is attached to the cover member 7. The septum unit 51 is inserted into the cylindrical member 44 of the inkjet head 4 by opening and closing the cover member 7.

As shown in FIG. 4A, the septum unit 51 which is a connection portion of the ink tube 5 is controlled not to move toward the inkjet head 4 with respect to the cover member 7 (a coaxial direction of the cylindrical tube in the connector 511). In addition, the septum unit 51 is swingably attached to within a predetermined limit in a plane direction of the cover member 70 (on a plane orthogonal to an axis of the cylindrical tube in the connector 511) so that it can be rattled. The aforementioned construction allows the septum unit 51 functioning as a connection portion to be surely inserted and engaged into the inkjet head 4 whenever the cover member 7 is opened and closed as described below.

Subsequently, the connection of the ink tube generated when the cover is opened and closed in inkjet recording apparatus according to the present invention will be described in detail.

When the inkjet head 4 is exchanged in the inkjet recording apparatus according to the present invention, first, the cover member 7 is rotated with respect to the carriage 3. Briefly, the cover member 7 is opened (refer to FIG. 4B). In this case, the cover member 7 is rotatably supported to an opposite side of the inkjet head with a guide rail 20 on which the carriage 3 slides interposed therebetween. With respect to this support, the cover member 7 is rotated to be opened, the inkjet head is installed or replaced in this state.

When replacement of the inkjet head 4 is completed, an operator closes the cover member 7, so that the ink tube 5 is connected to the inkjet head 4.

When the cover member 7 is closed, an inner side of the arm 71, i.e., a surface facing the guide rail 20 is abutted on the rail 31 functioning as an abutting member provided in the carriage 3. The rail 31 is provided such that the arm 71 can be slightly deformed in the state that the cover member 7 is closed. This allows the arm 7 to be abutted on and slide on the rail 31 to control the opening and closing operation even when the arm 7 is not accurately attached to the carriage 3, so that the septum unit 51 can be positioned right over the cylindrical member 44 to which the inkjet head 4 is to be connected.

In addition, when the arm 71 is abutted on and slid on the rail 31, the lever 73 is first abutted on the head body 42 of the inkjet head. Again, the head pressing portion 72 provided on a surface facing the inkjet head 4 of the cover portion 70 is abutted on the cap 43 of the inkjet head 4. The lever 73 presses the inkjet head 4 toward the guide rail 20, and the head pressing portion 72 presses the inkjet head 4 toward the carriage (i.e., to a platen 1) by virtue of a restoration force of a compressive spring so that the inkjet head 4 can be appropriately positioned.

When the arm portion 71 is rotated, the cap 513 of the septum unit 51 attached to the cover member 70 makes contact with the cylindrical member 44 of the inkjet head 4.

In the inkjet recording apparatus according to the present invention, the cover member 7 is constructed such that the cover member 7 is rotatably supported by an opposite side of the inkjet head 4 with the guide rail 2 where the carriage 3 slides on interposed therebetween, i.e., its rotation center is distant from the support location of the septum unit 51. Therefore, the septum unit 51 can be inserted into the cylindrical member 44 of the inkjet head in a nearly vertical direction.

In addition, since the connector 511 of the septum unit 51 is swingably attached in a plane direction of the cover member 70 (in an arrow direction shown on right of FIG. 5) by forming the connector attaching hole of the cover member 70 having a larger size than the outer size of the connector 511, the septum unit 51 can slide on a slanted plane of the cylindrical member 44 of the inkjet head 4 when the cover member 7 is rotated. As a result, the septum unit 51 is surely guided to the center portion of the cylindrical member 44 as shown in FIG. 6, and inserted into the cylindrical member 44 when the cover member 7 is rotated, so that the pipe 45 opens the slit of the elastic member 512, and the ink path of the ink tube 5 is connected to the head body functioning as an ink storage unit in the inkjet head 4. In this state, the hook 74 of the cover member 7 is abutted on the carriage 3 so as to be locked, the inkjet head 4 is appropriately positioned, and the connection between the ink tube 5 and the inkjet head 4 is fixed.

As a result, the replacement of the inkjet head 4 and the connection with the ink tube 5 are completed.

The inkjet recording apparatus of the present embodiment is constructed such that two kinds of inkjet heads including a black inkjet head and a color inkjet head for three colors are mounted on the carriage. If other types of inkjet heads different from those to be originally installed are provided in the carriage, and the ink tube is connected to it, a recording error may occur, and, if possible, a usage error of the inkjet head occurs. In order to prevent such errors, in the inkjet recording apparatus according to the present invention, when an inappropriate type of inkjet head is mounted on the carriage, the pressing element of the cover member is positioned to interfere with the cylindrical member of the inkjet head so that the cover cannot be closed.

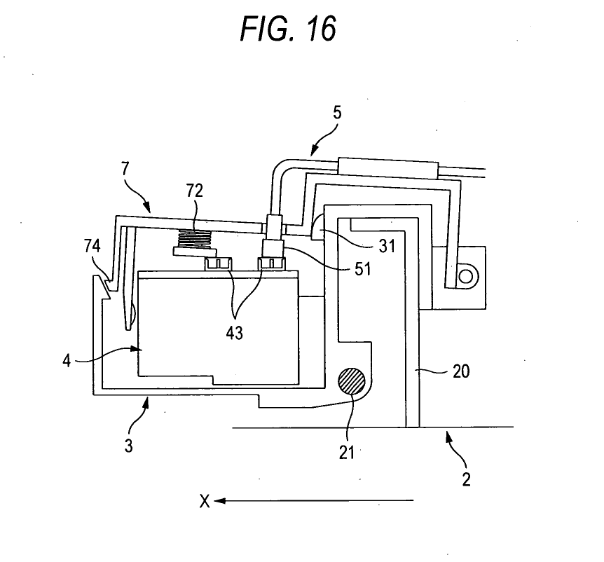

In other words, FIG. 16 shows the case that the color inkjet head 4 (having a plurality of cylindrical members 44) is installed in a partition for the black inkjet head 4 (of which the cover member 7 has only one ink tube 5) in the carriage 3. In this case, even when we tries to close the cover member 7 to connect the ink tube 5 with the inkjet head 4, the head pressing portion 72 is abutted on the cylindrical member 44 of the inkjet head in advance, so that the arm 7 cannot be rotated any more. As a result, the hook 74 cannot reach the carriage 3, and the septum unit 51 cannot reach the cylindrical member 44.

In order that the cover member is not closed by interfering with the cylindrical member of the inkjet head when an inkjet head having a type different from that to which the ink tube should be connected is mounted on the carriage, the head pressing portion 72 is formed in a shape corresponding to the remaining portion excluding the regions for the cylindrical members 44 in the cap 43 of the inkjet head 4 to which the head pressing portion 72 is to be positioned.

As a result, it is possible to prevent errors in installation of the inkjet head in the inkjet recording apparatus according to the present invention.

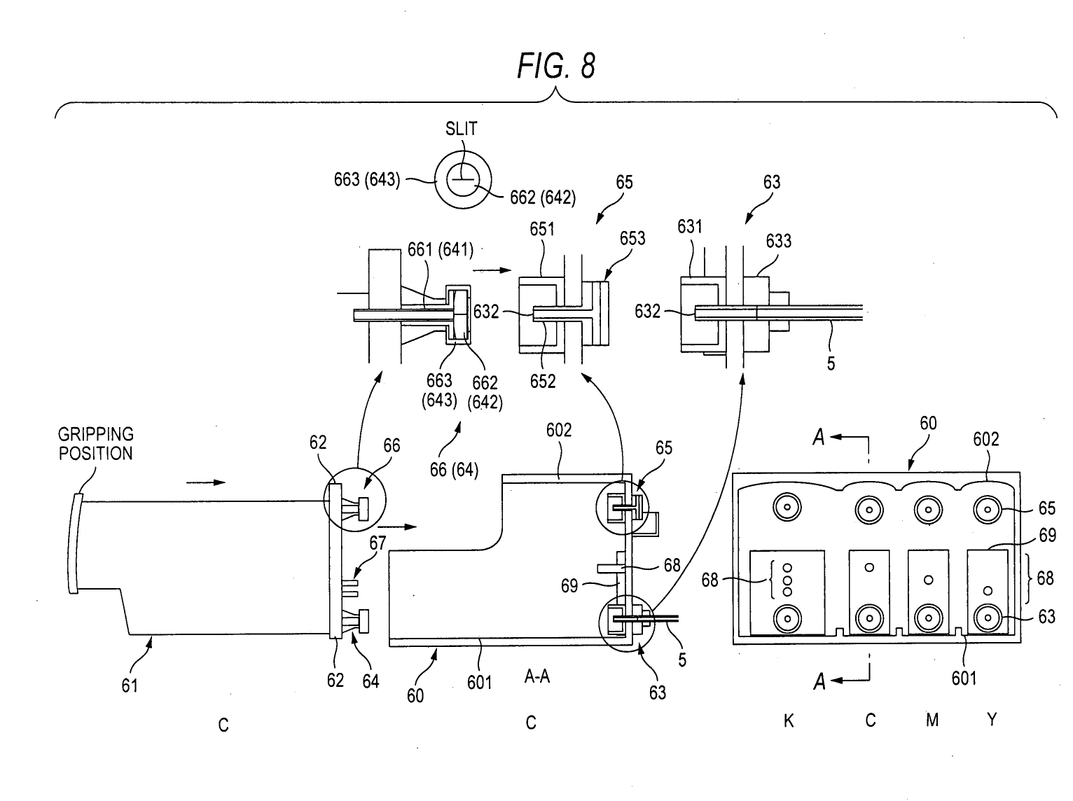

FIG. 8 is a view showing a construction of an ink tank unit 6 of the inkjet recording apparatus according to the present invention. The ink tank unit includes a base 60 disposed so as to be fixed on the recording apparatus body 1 and an ink container 61 which is detachably attached on the base 60.

The ink container 61 is installed to store the ink in the container. The ink container 61 is provided with an atmosphere opening hole 66 and an ink supply inlet 65 that are vertically distant from each other on the same surface. The atmosphere opening hole 66 connects the atmospheric air with a space which is charged with no ink and disposed in an upward direction of the container in order to atmospherically open the container and exert the atmospheric pressure on the stored ink. The ink supply inlet 64 is used to supply the ink stored in the container from a lower portion of the container to the ink flow path. The atmospheric opening hole 66 and the ink supply inlet 64 respectively include a connector 661 and 641 having in its center portion a tube which penetrates into the ink container 61 to provide a flow path, an elastic member 662 and 642 which is made of rubber having a slit in its center portion and abutted on an end of the connector 661 and 641, and a cap 663 and 643 for capping the connector to allow the slit provided in the center portion of the ink container 61 to be exposed and allow the elastic member to be covered. When the ink container 61 is separated from the base 60, the slit of the elastic body 662 and 642 provided in the atmospheric opening hole 66 and the ink supply inlet 64 is closed. Since each flow path is closed, the ink container 61 is hermetically sealed, and the ink stored in the container is not leaked out.

In addition, a guide 62 is adjacently provided on a plane where the atmospheric opening hole 66 and the ink supply inlet 64 of the ink container 61 are disposed. The guide 62 is formed to have a larger cross-sectional shape in comparison with the ink container 61. As described below, the guide 62 functions as a guiding member for abutting the ink container 61 on the base 60 and sliding it. In addition, a protrusion 67 is provided on a plane where the atmospheric opening hole 66 and the ink supply inlet 64 of the ink container 61 are disposed. The protrusion 67 of the ink container 61 is combined with the protrusion 68 of the base 60, which will be described below, to prevent inappropriate insertion of the ink container 61.

The base 60 is fixedly installed in the recording apparatus body 1. Also, the base 60 is provided with a first joint 63 and a second joint 65 which functions as an air joint. The first joint 63 and a second joint 65 are distant in a vertical direction and correspondingly connected with the ink supply inlet 64 and the atmospheric opening hole 66 of the ink container 61.

In addition, as shown on right of FIG. 8, the base 60 is constructed such that inner surfaces 602 and 601 of an upper and lower planes of the base 60 are almost matched with the shape of the guide 62 of the supported ink container 61 in a front view to form the rails 601 and 602 for sliding the guide 62, which will be described below.

The second joint 65 functioning as an air joint includes a cylindrical member 651 engaged with (the cap 663 of) the atmospheric opening hole 66 of the ink container 61, a pipe 652 which is a cylindrical tube member provided in the center portion of the cylindrical member 651, and an air joint body 653 attached to the base 60 and connected to the flow path of the pipe 652 to divide it into a flow path for an atmospheric opening and a downward flow path. In addition, the first joint 63 includes a cylindrical member 631 engaged with the ink supply inlet 64 of the ink container 61, a pipe 632 which is a pipe-shaped tube member provided in the center portion of the cylindrical member 631, and a connector 633 attached to the base 60 and connecting the flow path of the pipe 631 with the ink tube 5.

A liquid absorber 69 such as sponge or non-woven fabric is attached around the cylindrical member 631 of the joint 63. As shown on right of FIG. 8, the liquid absorber 69 is attached so as to adjoin with a circumference and a vertically lower portion of the joint 63 and the rail 601.

Specifically, the liquid absorber 69 may include sponge composed of a porous material such as polyvinylalcohol.

Between the first and second joints 63 and 65, a protrusion 68 is provided according to a type of the ink container to be connected thereto to prevent inappropriate insertion of a different type of ink container 61 as described below.

In the inkjet recording apparatus according to the present invention, when the ink container is inserted into the recording apparatus body, an operator grips an end of the ink container 61 such that a surface to which the atmospheric opening hole 66 and the ink supply inlet 64 are installed faces the base 60, and inserts it such that the guide 62 of the ink container 61 is abutted on the rail 601 and 602. Then, the guide 62 is slid to be positioned on the rail 601 and 602, and the atmospheric opening hole 66 and the ink supply inlet 64 provided in its end reach corresponding joints 65 and 63. In the ink tank unit 6 according to the present invention, a guide is adjacently provided on a plane where the atmospheric opening hole and the ink supply inlet of the ink container are installed. When the atmospheric opening hole and the ink supply inlet are connected to the joint, the guide is slid on the rails 601 and 602 provided on the base. Therefore, even if the ink container is swayed when the ink container is positioned for the atmospheric opening hole and the ink supply inlet, i.e., when an operator grips an opposite end to a plane having the guide in the ink container to insert it into the base, the amount of deviation is reduced near the guide, so that the positioning of the atmospheric opening hole and the ink supply inlet can be guaranteed for each joint. The atmospheric opening hole and the ink supply inlet are engaged with the joints 65 and 63, respectively, by inserting the container.

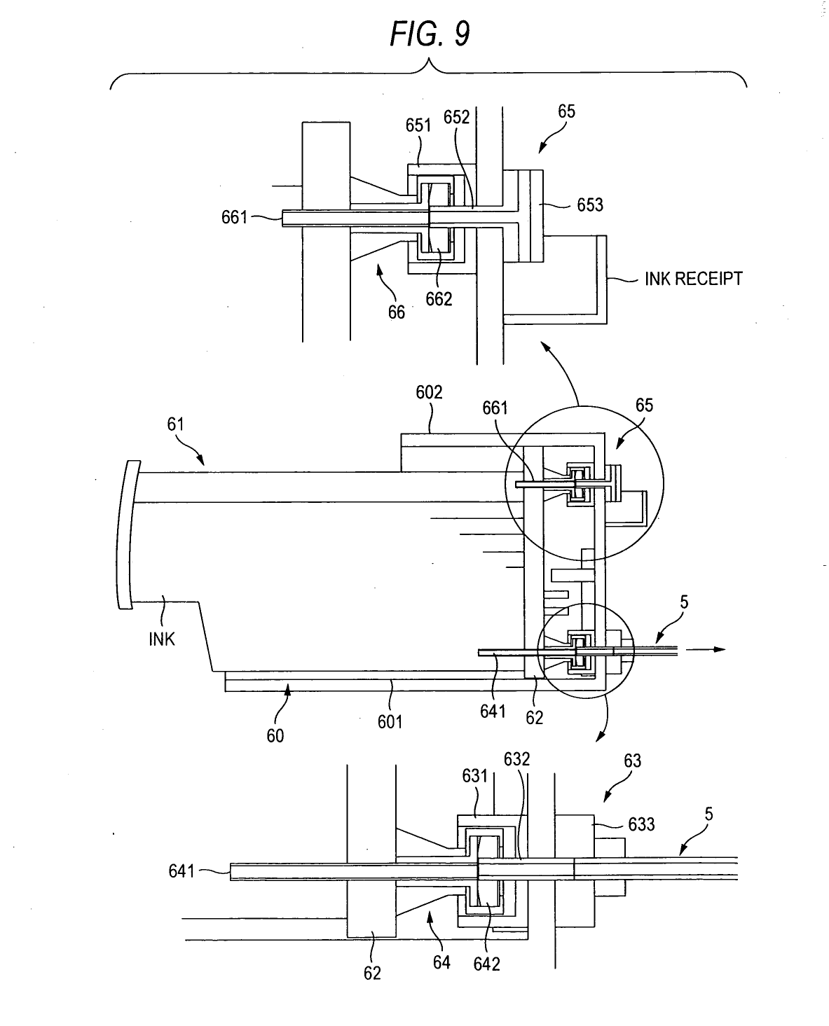

When the ink tank unit 6 is further pushed after the atmospheric opening hole and the ink supply inlet are engaged into the joints 65 and 63, the pipe 652 and 632 provided in each joint elastically deforms the elastic member 662 and 642 to open the slit. When the ink tank unit 6 is fully engaged, an end of the pipe 652 from the atmospheric opening hole 66 is connected to the tube installed in the center of the connector 661, so that the ink container is atmospherically opened. Similarly, an end of the pipe 632 from the atmospheric opening hole 64 is connected to the tube installed in the center of the connector 641, so that the ink stored in the ink container is connected to the ink tube 5 (the ink path) (refer to FIG. 9).

As shown on center f FIG. 6, in a recording operation, when the heater 414 provided adjacent to the nozzle 416 in the head portion 41 is operated, the surface temperature of the heater 414 is abruptly raised, so that neighboring ink is instantaneously vapored, and bubbles are generated in the chamber 415. As a result, the ink is pushed out by the bubbles generated in the corresponding nozzle 416, and these bubbles become droplets and ejected to outside. When an electric current is not supplied to the heater 414, the surface temperature decreases, and the bubbles are cooled by the ink, so that they are shrunken and disappeared. Finally, the ink is supplied from the ink supply channel 413 (cartridge 42) to the chamber 415 by a capillary action. By controlling the operation of the heater 414 as described above, the ink is ejected from the head portion with a predetermined timing appropriate to execute a desired recording.

When the ink is ejected from the head portion 41 of the inkjet head 4, since the ink contained in the ink containing body 46 is output to the head portion 41, the sealed inkjet head 4 has a negative pressure. In the inkjet recording apparatus of the present invention, the ink path has a sealed state, and also, as described above, an atmospheric pressure is exerted on the ink in the ink tank 6. Therefore, the same amount of ink as that sucked from the ink tank 6 and ejected is loaded from the pipe 45 through the ink tube 50 and septum unit 51 to the inside of the cartridge, and then retained in the ink retaining body 46. That is, the ink is supplied from the ink tank 6 to the inkjet head 4.

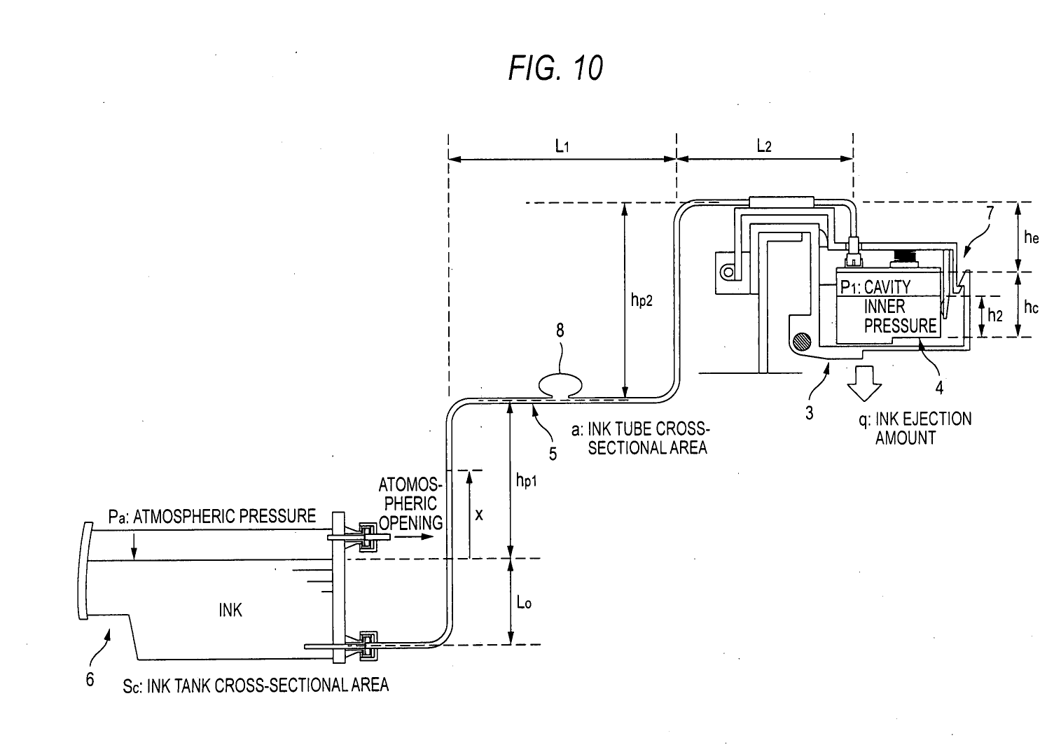

FIG. 10 is a modeling diagram showing a construction of an ink supply system and main parameters in the inkjet recording apparatus according to the present invention. Also, FIG. 10 describes the aforementioned principle in more detail in association with FIG. 1, where like reference numerals designate like elements. As describe above, the ink container 61 of the ink tank unit 6 is combined with the base 60, and the ink tube 5 is connected to the inkjet head 4 by closing the cover member 7 provided in the carriage 3. In this state, the ink path from the atmospherically opened ink tank through the ink tube to the inkjet head is sealed. Therefore, a variation of an inner pressure generated by ejecting the ink from the inkjet head does not produce any access of a material.

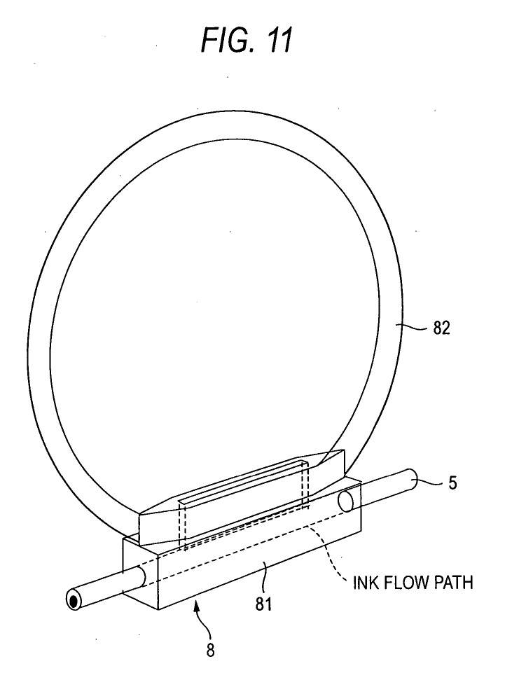

In the drawings, the reference numeral 8 designates a pressure stabilizer. As shown in FIG. 11, the pressure stabilizer 8 includes a ferrule 81 connected to the ink tube provided on the ink path and a bag 82 which is made of a vinyl, a flexible film, or the like, and is connected to the ferrule 81 to allow access of the ink. The bag 82 for allowing access of the ink is constructed such that its inner space has a negative pressure and contraction is generated when only an atmospheric pressure Pa is exerted thereto. Also, the ferrule 81 has an ink path which has an inner diameter (a) similar to that of the ink tube and is provided in a portion where the ink tube 5 is connected. Due to this construction, the ink path can be obtained even when the bag is contracted. The bag 82 is connected to the ink path provided in the ferrule 81, so that the ink is input and output from/to the ink path. The pressure stabilizer 8 is installed in an arbitrary position higher than the ink liquid height L0 in the ink tank 6.

The ink does not inflow to the bag 82 of the pressure stabilizer 8 in a steady state (at an atmospheric pressure Pa) However, when the air stored in the cavity or the ink tube is expanded as a circumferential temperature around the inkjet recording apparatus increases, the ink or air in the ink path (or the ink tube 5) inflows to the bag 82, so that the pressure increase in the ink path is stabilized. That is, by installing the pressure stabilizer 8, it is possible to prevent an ink droplet from falling down from the ink ejection nozzle of the inkjet head 4 due to a variation of the temperature.

In the ink supply system of inkjet recording apparatus according to the present invention, a basic model can be obtained from fluid kinematics of fluid flowing through a circular pipe of same diameter. As described above in association with the principles (FIG. 2), by approximating the Navier-Stokes equation using a mean flow velocity v in a cross-section of the pipe, the following unsteady state derivative equation can be obtained.

$$ρ ( {L}_{0} + x ) \frac{ⅆ v}{ⅆ x} = [ {P}_{a} - {P}_{1} - ρ gy ] - ρ ( {L}_{1} + x ) \frac{8 πμ}{ρ a} v \qquad ( 1 )$$

The left side is an inertia term; the first term in right side is a driving force term; and the second term in the right side is a viscous resistance term.

Where, v is velocity of ink in a ink tube, ρ is density of ink, μis viscosity of ink, Pa is atmospheric pressure, P1 is pressure of isolated air in inkjet head and ink tube, and a is the cross-sectional area of the ink tube. In the following descriptions, a leading head position x of ink in the ink tube will be represented by a distance from the ink surface height L0 in the ink tank 6.

In equation 1, y is the surface height of an ink leading head in the ink tank 5, i.e., a vertical position, and can be represented by the following equation in the respective position in the ink tube shown in FIG. 10.

$$y = \{ \begin{matrix}x & ( 0 \leq x \leq {h}_{p 1} ) \\ {h}_{p 1} & ( {h}_{p 1} \leq x \leq {h}_{p 1} + {L}_{1} ) \\ x - {L}_{1} & ( {h}_{p 1} + {L}_{1} \leq x \leq {h}_{p 1} + {L}_{1} + {h}_{p 2} ) \\ {h}_{p 1} + {h}_{p 2} & ( {h}_{p 1} + {L}_{1} + {h}_{p 2} \leq x \leq {h}_{p 1} + {L}_{1} + {h}_{p 2} + {L}_{2} ) \\ x - {L}_{1} & ( {h}_{p 1} + {L}_{1} + {h}_{p 2} + {L}_{2} \leq x \leq {h}_{p 1} + {L}_{1} + {h}_{p 2} + {L}_{2} + {h}_{e} )\end{matrix} \qquad ( 2 )$$

In the above Equation 1, when ink in the ink supply system is not in motion (v=0, dv/dt=0), the driving force term becomes 0 in the Equation 1. That means that the pressure P1 in a cavity of the inkjet head becomes equilibrium with the difference between atmospheric pressure Pa and water head pressure ρgy.
P₁=Pₐ−ρgy (3)

An internal pressure P1 of the cavity is normally maintained at a low value that is less than the atmospheric pressure Pa and also than the water head pressure ρgy, however, when the internal pressure P1 of the cavity is changed to a lower value, the equilibrium is lost, and as a result, the movement of ink is initiated to raise ink in the tube. This movement of ink in the tube is continued until the water head pressure term ρgy in Equation 3 cancels the reduced quantity of the new P1, and an equilibrium state is finally met in this state.

Now, the phenomenon of internal pressure P1 of the cavity will be examined. Assuming that p is the quantity of ink flow discharged from nozzle arrays of the inkjet head after the inkjet head is driven, the ink height h2 in the inkjet head is decreased by the ratio represented by Equation 4 before the ink reaches a print head.

$$\frac{ⅆ {h}_{2}}{ⅆ t} = - \frac{q}{{S}_{c}} ( x < {h}_{p 1} + {L}_{1} + {h}_{p 2} + {L}_{2} + {h}_{e} ) \qquad ( 4 )$$

Here, it is assumed that the ink is incompressible, fluid and Sc in this Equation is the bottom surface area of the inkjet head. As h2 decreases, air volume in the inkjet head increases, and the internal pressure P1 of the cavity decreases. The decreased pressure produces the movement of ink as described above, and the movement of ink in the ink tube 5 is initiated, whereby the ink in the ink tube 5 (i.e., the leading head position X of the ink along the ink tube 5) is driven toward the inkjet head 4. In addition, when the ink (the leading head position X thereof) has already reached the inkjet head 4, a change in the ink height in the inkjet head 4 is determined by the equilibrium between the quantity q of ink flow discharged from nozzle arrays of the inkjet head 4 and the quantity va of ink flow from the ink tube 5, as represented by Equation 5.

$$\frac{ⅆ {h}_{2}}{ⅆ t} = \frac{va - q}{{S}_{c}} ( x \geq {h}_{p 1} + {L}_{1} + {h}_{p 2} + {L}_{2} + {h}_{e} ) \qquad ( 5 )$$

In this case, when the quantity va of the ink flow from the ink tube 5 is equivalent to the quantity q of the ink flow discharged from nozzle arrays of the inkjet head 4, there is no change in the ink height in the inkjet head 4.

Next, taking into consideration of the relationship between the internal pressure P1 of the cavity and the air volume in the cavity, Equation 6 can be established with respect to the air isolated in the cavity and the ink tube assuming the air in the cavity follows the Boyle-Charles' rule.

$${P}_{1} = \frac{{c}_{0} T}{{S}_{c} ( {h}_{c} - {h}_{2} ) + a ( L - x )} ( L = {h}_{p 1} + {L}_{1} + {h}_{p 2} + {L}_{2} + {h}_{e} ) \qquad ( 6 )$$

where, the denominator in this equation is the total volume of the air isolated in the cavity and the ink tube as represented by the leading head position X of the ink in the ink tube 5, and C0 is a parameter representing the number of molecule in the isolated air (C0=knN, k: the Boltzmann constant, N: the Avogadro constant, n: a mole number).

The above Equations (1), (2), (4), (5), and (6) are a group of equations indicating the supply of ink in the ink supply system of the inkjet recording apparatus according to the present invention.

Next, using the aforementioned basic equation, the behaviors in the ink supply system can be simulated under various parameters. However, since these equations are non-linear and cannot be solved in an analytic manner, these equations will be solved in a numerical manner by using the Runge-Kutta method.

Moreover, all the constants used in this analysis are assumed as shown in Table 1.

TABLE 1

| | | | | | | | | |
|---|---|---|---|---|---|---|---|---|
| constant | Sc | a | hc | hp1 | hp2 | L | L0 | L1 |
| numerical value | 12 | 0.031416 | 3 | 7 | 12 | 114 | 5 | 82 |
| unit | cm² | cm | cm | cm | cm | cm | cm | cm |

| | | | | | | |
|---|---|---|---|---|---|---|
| constant | L2 | he | pa | T0 | V0 | C0 |
| numerical value | 10 | 3 | 1000000 | 288 | 15.58142 | 54102.14 |
| unit | cm | cm | dyn/cm² | K | cm³ | erg/K |

| | | | | | | |
|---|---|---|---|---|---|---|
| constant | ρ | g | h2i | μ | dt | q |
| Numerical value | 1 | 980 | 2 | 0.027 | 0.1 | 0.01 |
| unit | g/cm³ | gcm/s² | cm | cp | s | cm³/s |

In an initial state where ink is not charged in the ink tube, the conventional inkjet recording apparatus is constructed such that the ink is supplied by sucking the ink from the ink tank disposed at a lower position to the inkjet head disposed at a higher position by using a suction means such as a pump. On the contrary, the inkjet recording apparatus according to the present invention is constructed such that an inkjet head stores a predetermined amount of ink in advance to allow a recording operation to be performed from the initial state where the ink is not charged in the ink tube without sucking the ink.

When the inkjet head which stores a predetermined amount of ink in advance is mounted on the carriage 3, and a cover member 70 is closed, the ink tube 5 is connected to the inkjet head 4, so that an ink flow path from ink tank 6 through the ink tube 5 to the inkjet head 4 is in a closed state. Although the ink tube 5 is not charged with the ink in the initial state, a recording operation is performed by using the ink stored in advance in the cartridge 42 if the recording operation is initiated in this state. When ink stored in the cartridge 42 is discharged from a head portion 41, the volume of the air isolated in the cavity and the ink tube is inflated. As a result, the pressure of the isolated air is decreased, the movement of ink is generated in the ink flow path, and the ink is input from the ink tank to the inkjet head 4. When the recording operation is further performed, the ink is sucked into the inkjet head 4 due to the discharge of ink. When the recording operation is continued in this state, the ink in the ink tube is sucked into the inkjet head 4, while the ink in the cartridge 42 is consumed. Although the amount of the ink in the inkjet head 4 is reduced before the ink in the ink tube 5 reaches the inkjet head, the same amount of ink as those consumed (discharged) by the recording operation is supplied to the inkjet head 4 through the ink tube 5 after the ink in the ink tube 5 reaches the inkjet head, whereby the ink height in the inkjet head 4 becomes constant.

In order to conduct a numerical experiment on the movement of ink using the aforementioned model, it is assumed that the initial height of the ink in the inkjet head 4 is set to 4 cm, and the recording operation begins from the position where the ink height in the ink tube 5 is equal to that in the ink tank 6. Also, itis assumed that, in the initial state, the isolated air in the cavity and the ink tube is at the atmospheric pressure and the temperature is constant.

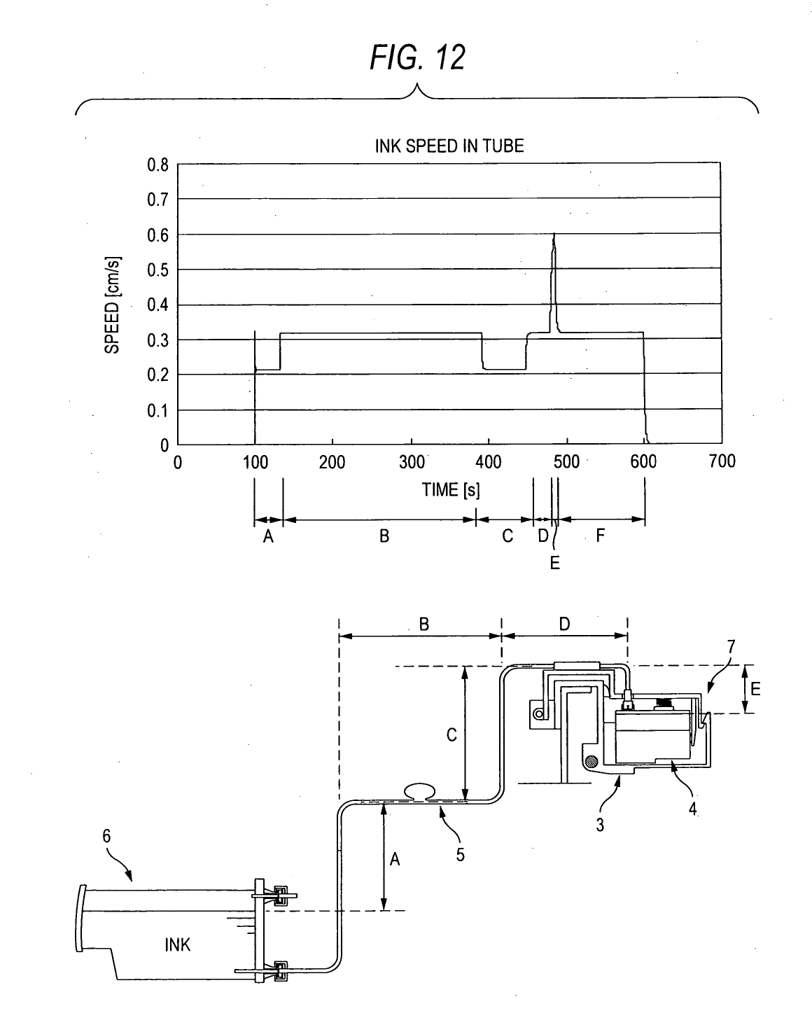

In FIG. 12, there is shown a speed change of the ink in the ink tube 5 when the discharge of ink from the inkjet head 4 begins at 100 sec with a fluid flow of q=0.01 cm3/s, and the discharge stops at 600 sec after the initial introduction is completed.

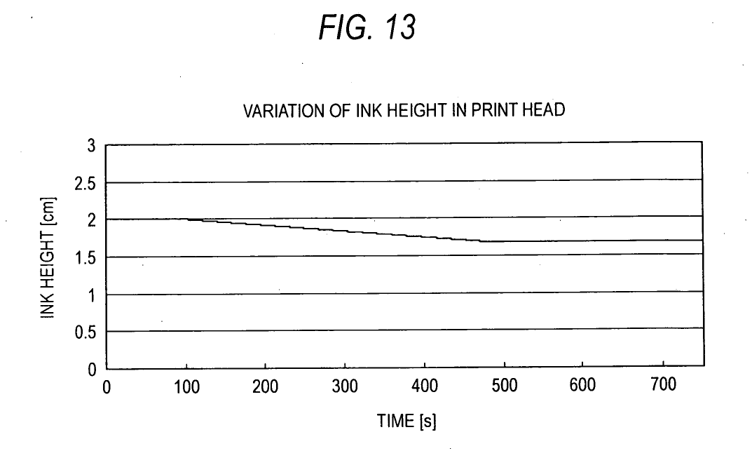

On top of FIG. 12, there is shown a speed of ink when the leading head of the ink is in each section of the ink tube 5 shown on bottom of FIG. 12. Specifically, the speed of ink decreases when the leading head of the ink is in the vertically rising sections (hp1 and hp2) in the ink tube 5, whereas the speed of ink becomes constant at v=0.318 cm/s after the leading head of ink reaches the inkjet head 4. The quantity of ink flow to the print head is determined by multiplying the cross-sectional area a of the ink tube 5 by this speed. This value is the same as the quantity of ink (q=0.01 cm3/s) discharged from the nozzle of the inkjet head. That means that the quantity of inflow and the quantity of outflow are equal to each other after the ink reaches the inkjet head. The ink height in the inkjet head 4 which was 2 cm at the initial state as shown in FIG. 13 begins to decrease from the time point (100 sec) when the recording operation starts. The decrease of the height stops from the time point 480 sec when the ink reaches the inkjet head 4, and a constant height is maintained thereafter.

As described below in detail, in the inkjet recording apparatus according to the present invention, a pipe system such as an ink tube having sufficiently high air-tightness and an inkjet head in which a predetermined amount of ink is stored in advance are used. Therefore, it is possible to initiate to supply the ink to the inkjet head without requiring a separate means and process for initially charging the inkjet head at the time of initiating the operation of the apparatus, and the like. Moreover, various parameters described above may be suitably changed based on the size of the recording sheet, the inner diameter of the ink tube, or the like, and it is possible to surely perform the initial ink charging operation by adopting appropriate values. In addition, the design of various parameters described above may be changed based on the size of the recording apparatus, the inner diameter of the ink tube, or the like, and it is possible to execute the initial ink charging operation by adopting optimal values.

In addition, in the inkjet recording apparatus according to the present invention, a predetermined amount of ink is stored in advance in the ink storage unit of the inkjet head, and the recording operation can be initiated by using this ink without performing an initial ink charging operation. As a method of charging the ink in the inkjet head to be used in the inkjet recording apparatus, first, the cylindrical member 44 (and the pipe 45) is attached and fixed in advance to the lid 43 which is attached to the cartridge 42 in the inkjet head 4 shown in FIG. 5 for closing it through a gasket. Meanwhile, the ink retaining body 46 is compressed from an upper opening of a cartridge 42 in the inkjet head 4 and stored, so that a predetermined amount of ink is charged in the ink retaining body 46. Then, the lid 43 to which the cylindrical member 44 is attached in advance is closely adhered to the opening of the cartridge 42 charged with the ink, and they are welded to hermetically seal the inkjet head 4. As a result, it is possible to obtain an inkjet head in which a predetermined amount of ink is stored in advance.

Alternatively, in the inkjet head 4 shown in FIG. 5, the ink retaining body 46 is be compressed from the opening of the cartridge 42 and stored in the inkjet head, the lid 43 is closely adhered to the upper opening, and they are welded. Then, using the hole where the cylindrical member 44 is to be attached, a predetermined amount of ink is charged in the ink storage unit in the cartridge 42, i.e., the ink retaining body 46. Next, the cylindrical member 44 (and pipe 45) is attached to the holes on the lid 43 through a gasket, and the inkjet head 4 is hermetically sealed. As a result, it is possible to obtain the inkjet head in which a predetermined amount of ink is stored in advance.

In the inkjet recording apparatus according to the present invention, an atmospheric opening hole for atmospherically opening the container and the ink supply inlet for supplying the stored ink to an ink flow path are perpendicularly provided on the same side surface of the ink container which is detachably provided with respect to the recording apparatus body. Therefore, it is possible to simply the construction of the ink container. In addition, each of the atmospheric opening hole and the ink supply inlet is constructed to include an elastic member having a slit. At the same time, the first and second joints are constructed to include a cylindrical member which the atmospheric opening hole and the ink supply inlet are engaged with and a pipe inserted into the slit to elastically deform it and open the flow path. Therefore, it is possible to prevent leakage of the ink generated by attaching and detaching the ink container as well as to charge the ink by exchanging only the ink container. In addition, the ink container includes a guide member which is adjacently disposed on a plane where the atmospheric opening hole and the ink supply inlet are provided, while the recording apparatus body includes a rail member to which the guide member is abutted on slide on it. Therefore, it is possible to allow the connection of the ink container to be implemented in a simple and secure manner.

The inkjet recording apparatus according to the present invention is constructed such that an ink flow path extending from the atmospherically opened ink tank through the ink tube to the inkjet head is provided, and the inkjet head has a negative pressure when the ink is discharged from the inkjet head, so that the ink is supplied from the ink tank through the ink tube. Therefore, although the ink is always charged in the ink tube corresponding to the ink flow path, the ink in the ink tube 5 may be reversely flow according to circumferential conditions such as an atmospheric temperature or an atmospheric pressure, so that the ink may leaks from the pipe 632 of the joint 63. In order to solve the above problem, the inkjet recording apparatus according to the present invention is constructed to have a liquid absorber provided in the first joint connected to the ink supply inlet of the ink container.

In other words, as shown on right and center of FIG. 8, the base 60 is provided with a liquid absorber 69 formed on an area where the first joint 63 connected to the ink supply inlet 64 of the ink container 61 is installed. The liquid absorber 69 is attached so as to adjoin with a circumference of the joint 63 and cover a vertically lower portion of the joint 63 and the rail 601.

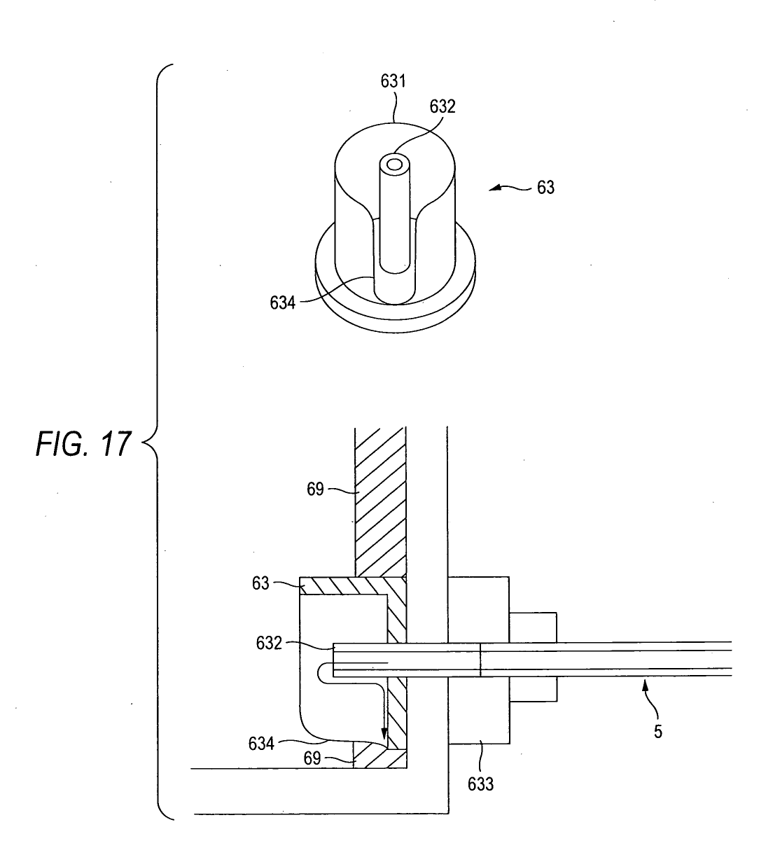

If the ink reversely flows from the ink tube 5 in the ink path when the ink container 61 is separated from the base 60, the ink leaks from the ink tube 5 from the pipe 632 of joint 63. However, even when the ink overflows from the cylindrical member 631, the ink is absorbed into the liquid absorber 69 provided so as to adjoin with the circumference of the joint 63 and a vertically lower portion of the joint 63. As a result, it is possible to prevent contamination of the recording apparatus body 1 caused by the ink reversely flowed from the ink flow path. In addition, as shown in FIG. 17, the ink reversely flowed from the ink flow path can be surely absorbed by forming a notch 634 under the cylindrical member 631 in a vertical direction in the joint 63. More specifically, as shown on bottom of FIG. 17, ink reversely flowed from the ink flow path reaches the inside of the cylindrical member 631 from the pipe 632 along the lower side of the outer circumference thereof and a droplet falls down in a vertical direction. In this embodiment of the present invention, a notch 634 is provided under the cylindrical member so that ink flows along the outer circumference of the cylindrical member 631. By this arrangement, it is possible to also prevent contamination of the inside of the cylindrical member 631.

In the aforementioned inkjet recording apparatus, when the ink container 61 is connected to the base 60, and the atmospheric opening hole 66 is engaged with the cylindrical member 65 of the air joint 65, the pipe 652 penetrates into the ink container, so that the inside of the ink container 61 is atmospherically opened through the air joint 65. However, if the recording apparatus body is installed on a slant, or if the ink in the container is rattled when the ink container 61 is replaced, the ink makes contact with an end of the pipe 652 inserted into the ink container 61, so that the ink may be flowed into the air joint 65 originally functioning as an air path for the atmospherical opening, and may be discharged from the opening hole. When the flow path of the air joint 65 is opened in only one direction, this ink may be remained in the flow path. In this case, even when the ink is ejected from the inkjet head, and the ink flow path becomes a negative pressure, the ink remained in the flow path of the air joint can not be perfectly returned to the ink container. As a result, the ejection of the head may be inappropriately operated.

Consequently, in inkjet recording apparatus according to the present invention, as shown in FIGS. 8 and 9, the flow path of the second joint 65 functioning as an air joint for atmospherically opening the ink container 61 is divided into a flow path for atmospherically opening the ink container 61 and a downward flow path. As a result, it is possible to discharge the ink from the downward flow path even if the ink is flowed into the pipe 652 of the air joint 63 when the ink container is combined with the base 60, and the ink is not remained in the flow path.

In addition, according to the present embodiment, a dish-shaped ink storing member is provided just under the air joint 65 to store the ink outflow from the air joint 65. Therefore, it is possible to prevent contamination of the recording apparatus body generated by unnecessary ink.

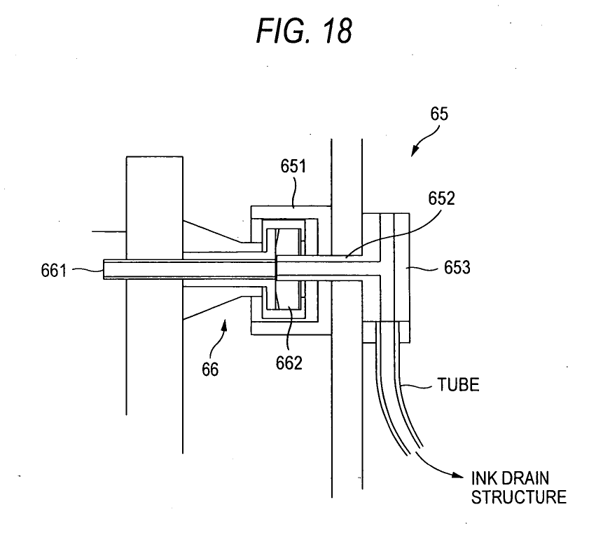

Otherwise, as shown in FIG. 18 as another example, a tube is connected to the downward flow path in the air joint 65, so that the outflow undesired ink is discharged into an ink discharge construction such as a head cleaning tool.

In this inkjet recording apparatus, when a color recording is performed by using a plurality of color inks, the tanks storing individual colors, the ink tube, and the inkjet head are provided. In this case, when an ink container different from that corresponding to a color ink to be connected to a predetermined ink path is connected, a different type of ink is supplied to the ink flow path and the ink head by a recording operation, so that an inappropriate recording will occur as well as damages on the inkjet head will be generated.

Therefore, in the inkjet recording apparatus according to the present invention, a unique protrusion according to a type of the inkjet container, i.e., the ink color stored in the ink tank, is formed on a plane where the atmospheric opening hole and the ink supply inlet are provided in the ink container. Also, the recording apparatus body is provided with a protrusion which faces the unique protrusion of the ink container to interfere with the unique protrusion of a different type of ink container such that the atmospheric opening hole and the ink supply inlet are not connected to the first and second joints.

As shown on right of FIG. 8, in the base 60 fixed on the recording apparatus body, the ink containers 61 for black (K), cyan (C), magenta (M), and yellow (Y) colors from the left side are connected to the first and second joints. In other words, the inkjet head for ejecting black (K), cyan (C), magenta (M), and yellow (Y) color inks in this order is connected to an end of the ink flow path connected to the first joint 63, and a cylindrical protrusion 68 is formed in a unique pattern between first and second joints 63 and 65.

In combination with this protrusion, a flat type protrusion 67 is provided between the atmospheric opening hole 66 and the ink supply inlet 64 of the ink container 61. The protrusion 67 of the ink container 61 is provided in a unique pattern corresponding to the protrusion 68 of the base 60 according to a type of the ink to be stored as shown in FIG. 7. As shown in FIG. 9, when the ink supply inlet and the atmospheric opening hole of the appropriate ink container 61 are inserted into the first and second joints, the protrusion 67 of the ink container 61 and the protrusion 68 of the base 60 are engaged with each other in a vertical direction, so that the ink tank 61 can be abutted on the base 60. On the contrary, when an inappropriate type of ink container is attached to and slides on the rails 601 and 602 of the base 60, for example, as shown in FIG. 7, when an ink container storing a cyan ink is inappropriately inserted for the first and second joints 63 and 65 where the ink container storing the magenta ink is to be connected, the protrusion 68 of the base 60 and the protrusion 67 of the ink container 61 collide and interfere with each other, so that the ink supply inlet 64 and the atmospheric opening hole 66 of the ink container 61 cannot reach the cylindrical members of the first and second joints 63 and 65.

According to the present invention, the ink container cannot be connected to a different type of joint other than that previously determined according to an ink type to be stored. Therefore, it is possible to prevent recording errors and damages in the inkjet head caused by inappropriately inserting the ink container.

What is claimed is:

1. An inkjet recording apparatus that moves an inkjet head mounted on a carriage in a main scan direction and ejects ink to perform recording, comprising:
an ink tank which is supported by a recording apparatus body and stores the ink; and
an ink tube which constitutes an ink path from the ink tank to the inkjet head, wherein
a predetermined amount of ink is contained in the inkjet head, and
the ink tube can be connected to the inkjet head.

2. The inkjet recording apparatus according to claim 1, wherein,
when the recording starts, the recording is performed by using the ink contained in the inkjet head, and
ink is supplied from the ink tank through the ink path to the inkjet head according to an ink amount ejected during the recording.

3. The inkjet recording apparatus according to claim 2, wherein
the inkjet head is closed by connecting the ink tube thereto, and
wherein an atmospheric pressure is exerted on the ink stored in the ink tank connected to the ink tube.

4. The inkjet recording apparatus according claim 1, wherein
the ink tube is provided with an elastic member in which a slit that opens and closes the ink path is formed, and
the inkjet head is provided with a pipe which is inserted into the slit of the elastic member provided to the ink tube, thereby elastically deforming the slit to open the ink path.

5. The inkjet recording apparatus according to claim 1, wherein
the inkjet head is a thermal type inkjet head.

6. The inkjet recording apparatus according to claim 1, further comprising a pressure stabilizer, which includes:
a ferrule which has an ink path connected to the ink tube; and
a bag which is connected to the ink path of the ferrule and allows the ink or air to flow in and out the ink path.

7. The inkjet recording apparatus according to claim 1, wherein
the inkjet head includes an ink storage unit,
a predetermined amount of ink is contained in the ink storage unit of the inkjet head,
the ink tube can be connected to the ink storage unit of the inkjet head,
the inkjet head is provided with a cylindrical member with which a connection portion of the ink tube is engaged, and
the cylindrical member is provided with a slanted plane for guiding the connection portion of the ink tube.

8. The inkjet recording apparatus according to claim 7, wherein
the connection portion of the ink tube is provided with an elastic member in which a slit that opens and closes the ink path is formed, and
the inkjet head is provided with a pipe which is inserted into the slit of the elastic member when the connection portion of the ink tube is engaged with the cylindrical member, thereby elastically deforming the slit to open the ink path and be connected to the ink storage unit of the inkjet head.

9. The inkjet recording apparatus according to claim 7, further comprising a cover member which is attached to the connection portion of the ink tube and is openably attached to the carriage so as to connect the ink tube to the inkjet head according to opening and closing operations thereof.

10. The inkjet recording apparatus according to claim 9, wherein
the connection portion of the ink tube is attached slidably in a plane direction of the cover member.

11. The inkjet recording apparatus according to claim 9, wherein
the cover member slides on an abutting member provided on the carriage to control the opening and closing operations.

12. The inkjet recording apparatus according to claim 9, wherein
the cover member is provided with a pressing unit that presses the ink head toward the carriage in a closed state.

13. The inkjet recording apparatus according to claim 12, wherein
when an inkjet head having a different type from the inkjet head to which the ink tube is to be connected is mounted on the carriage, the pressing unit is positioned to interfere with the cylindrical member of the inkjet head so as to prevent the cover member from closing.

14. The inkjet recording apparatus according to claim 1, wherein
an inkjet head includes an ink storage unit,
a predetermined amount of ink is contained in the ink storage unit of the inkjet head,
the ink tube can be connected to the ink storage unit of the inkjet head,
the inkjet recording apparatus further comprises a cover member which is attached on the connection portion of the ink tube and is openably attached to the carriage, and
the ink tube is connected to the inkjet head according to opening and closing operations of the cover member to the carriage.

15. The inkjet recording apparatus according to claim 14, wherein
the inkjet head is provided with a cylindrical member with which a connection portion of the ink tube is engaged, and
the connection portion of the ink tube is connected to the cylindrical member of the inkjet head according to opening and closing operations of the cover member.

16. The inkjet recording apparatus according to claim 14, wherein
the cylindrical member of the inkjet head is provided with a slated plane that guides the connection portion of the ink tube.

17. The inkjet recording apparatus according to claim 14, wherein
wherein the connection portion of the ink tube is provided with an elastic member in which a slit that opens and closes the ink path is formed, and
the inkjet head is provided with a pipe which is inserted into the slit of the elastic member when the connection portion of the ink tube is engaged with the cylindrical member, thereby elastically deforming the slit to open the ink path and be connected to the ink storage unit of the inkjet head.

18. The inkjet recording apparatus according to claim 14, wherein
the connection portion of the ink tube is attached swingably in a plane direction of the cover member.

19. The inkjet recording apparatus according to claim 14, wherein
the cover member slides on an abutting member provided to the carriage to control the opening and closing operations.

20. The inkjet recording apparatus according to claim 14, wherein
the cover member is rotatably supported to an opposite side of the inkjet head with a guide rail on which the carriage slides interposed therebetween.

21. The inkjet recording apparatus according to claim 14, wherein
the cover member is provided with a pressing unit that presses the ink head in a direction of the carriage in a closed state.

22. The inkjet recording apparatus according to claim 21, wherein,
when an inkjet head having a different type from the inkjet head to which the ink tube is to be connected is mounted on the carriage, the pressing unit is positioned to interfere with the cylindrical member of the inkjet head so as to prevent the cover member from closing.

23. The inkjet recording apparatus according to claim 1, wherein
an inkjet head includes an ink storage unit,
a predetermined amount of ink is contained in the ink storage unit of the inkjet head,
the ink tube can be connected to the ink storage unit of the inkjet head, and
the ink tank unit includes:
an ink container which is detachably mounted on a recording apparatus body and includes an atmospheric opening hole that atmospherically opens the container and an ink supply inlet that supplies the stored ink to the ink path, the atmospheric opening hole and the ink supply inlet being provided on a same side surface and perpendicular to the side surface;
a first joint which is supported by the recording apparatus body and connects the ink tube to the ink supply inlet of the ink container; and
a second joint which is supported by the recording apparatus body and connected to the atmospheric opening hole of the ink container to atmospherically open the ink container.

24. The inkjet recording apparatus according to claim 23, wherein
each of the atmospheric opening hole and the ink supply inlet of the ink container is provided with an elastic member in which a slit that opens and closes the ink path is formed, and
the first and second joints are provided with a cylindrical member wherein the atmospheric opening hole and the ink supply inlet are engaged with and a pipe which is inserted into the slit of the elastic member for elastically deforming the slit to open the ink path.

25. The inkjet recording apparatus according to claim 23, wherein
the first joint is provided with a liquid absorber.

26. The inkjet recording apparatus according to claim 24, wherein
the first joint has a notch disposed under the cylindrical member in a vertical direction.

27. The inkjet recording apparatus according to claim 23, wherein
the ink container has a guide member disposed adjacent to a plane in which the atmospheric opening hole and the ink supply inlet are provided, and
the recording apparatus body is provided with a rail member on which the guide member of the ink container slides, when the atmospheric opening hole and the ink supply inlet of the ink container are connected to the first and second joints.

28. The inkjet recording apparatus according to claim 23, wherein
the second joint is provided with a flow path for atmospherically opening the ink container and a downward flow path.

29. The inkjet recording apparatus according to claim 28, wherein
an ink storing member is provided just under the second joint.

30. The inkjet recording apparatus according to claim 28, wherein
the downward flow path of the second joint is provided with a tube for draining the ink.

31. The inkjet recording apparatus according to claim 23, wherein
a unique protrusion according to a type of the inkjet container is formed on a plane in which the atmospheric opening hole and the ink supply inlet are provided in the ink container, and
the recording apparatus body is provided with a protrusion which faces the unique protrusion of the ink container to interfere with the unique protrusion of a different type of ink container such that the atmospheric opening hole and the ink supply inlet are not connected to the first and second joints, when an ink container having a different type from that of the corresponding ink container is installed.

32. An ink charging method for an inkjet recording apparatus, which includes:
an inkjet head having an ink storage unit and mounted on a carriage, the inkjet head moving in a main scan direction and ejecting ink to perform recording;
an ink tank which is supported by a recording apparatus body and stores the ink; and
an ink tube which constitutes an ink path from the ink tank to the inkjet head, wherein
a predetermined amount of ink is contained in the ink storage unit of the inkjet head, and the ink tube can be connected to the ink storage unit of the inkjet head, and
the inkjet head includes an ink storage unit in which the ink is charged, an cap member that closes the ink storage unit, and a cylindrical member with which a connection portion of the ink tube is engaged,
the method comprising closing attaching the cap member having the cylindrical member to the ink storage unit after charging the ink in the ink storage unit, thereby charging the ink in the inkjet head.

33. An ink charging method for an inkjet recording apparatus, which includes:
an inkjet head having an ink storage unit and mounted on a carriage, the inkjet head moving in a main scan direction and ejecting ink to perform recording;
an ink tank which is supported by a recording apparatus body and stores the ink; and
an ink tube which constitutes an ink path from the ink tank to the inkjet head, wherein
a predetermined amount of ink is contained in the ink storage unit of the inkjet head, and the ink tube can be connected to the ink storage unit of the inkjet head, and
the inkjet head includes an ink storage unit in which the ink is charged, an cap member that closes the ink storage unit, and a cylindrical member with which a connection portion of the ink tube is engaged,
the method comprising attaching the cylindrical member to ink storage unit after attaching the cap member to the ink storage unit and charging the ink in the ink storage unit, thereby charging the ink in the inkjet head.
